(19) United States
(12) Patent Application Publication
(10) Pub. No.: US 2005/0114182 A1
(43) Pub. Date: May 26, 2005

(54) Method and apparatus for generating patient reminders

(76) Inventors: Robin Lynn Randolph, Morrison, CO (US); David Bamet Gersh, Rochester, NY (US); Philip Lee Miller, Peachtree City, GA (US); Donley Ray Psimer, Dunwoody, GA (US)

Correspondence Address: GOTTLIEB RACKMAN & REISMAN PC, 270 MADISON AVENUE, 8TH FLOOR, NEW YORK, NY, 100160601, US

(21) Appl. No.: 10/934,540

(22) Filed: Sep. 4, 2004

Related U.S. Application Data
(60) Provisional application No. 60/500,866, filed on Sep. 5, 2003.

(51) Int. Cl. G06F 17/60

(52) U.S. Cl. 705/2

(57) ABSTRACT

A patient reminder system for a plurality of patient sites with home care devices includes a patient server is provided with a database containing information about the devices, their manufacturer and a list of payors that provide payment to patients under certain conditions dictated by a set of rules. The server monitors the sites for devices eligible for a payment, replacement or a new accessory. When such an event is detected, a message is generated and sent to the patient. Alternatively, the server monitors the dispensal of drugs and generates a message when the prescription of a drug expires or needs renewal.

### RELATED APPLICATIONS

This application claims priority to provisional application Ser. No. 60/500,866 incorporated herein by reference.

### BACKGROUND OF THE INVENTION

A. Field of Invention

This invention pertains to a system that maintains a database of the rules governing payment for home care devices. The system uses these rules to generate patient reminders indicating when a patient is eligible for a payment for a home care device or its accessories. The server can also be used to monitor a patient's drug prescriptions and generates a reminder when a prescription needs to be renewed or is expiring.

B. Background of the Invention

For many ailments, it is advantageous to provide therapy or monitor a patient's condition right in his own home. Examples of such home care devices include respiratory devices for treating sleep apnea, blood pressure monitors, blood sugar monitors, cardiac monitors, and so on. Each payor, such as a health insurance company, has its own set of rules for determining how and when it will pay for these home care devices.

In addition, many home care devices have accessories that need replacements or replenishment at regular intervals. For example, devices for treating sleep disordered breathing, especially sleep apnea, include masks that should be replaced at regular intervals. Payors also have specific rules for paying for these accessories.

It would be advantageous for the manufacturers and distributors of home care devices to be able to determine where these home care devices are deployed and used, how are the patients using these home care devices, and when are patients eligible for payment from a respective payor. The patients would also benefit from such a system.

Similarly, both patients and drug companies would benefit from a system that monitors the drug prescriptions of patients and generates patient reminders when a drug prescription is expiring or needs renewal.

### SUMMARY OF THE INVENTION

A system is disclosed for monitoring the deployment of home care devices. The system includes a patient server with a patient interface receiving information from a plurality of patient sites, each patient site having a home care device, and a processor that receives the information and determines whether the patient is eligible for a payment and/or a new device or accessory. The processor then generates a reminder message when the patient is found to be eligible. The reminder message may be presented to a user. The user can then communicate with the patient by various known means and makes an offer to the patient of a new device or accessory. If the patient accepts, the user can request the system to automatically schedule a pick up from the patient (if applicable) and the delivery of the new device or accessory through an appropriate courier service. The reminder may also be generated automatically, i.e., without a positive action by a user.

The patient server further comprises a user interface through which a user can obtain various reports, and a display that presents the reports to the user. The display also presents the reminder message, so that a user can edit it, and then send it to the patient as a regular letter, a fax, or an e-mail message. The user may also be a health care provided (e.g., a doctor) who obtains from the server information about the patient, including information on whether the patient is using the device in the subscribed manner, or not.

The home care device can include an accessory, and the processor can generate another reminder message when the accessory is eligible for replacement.

The patient server includes a database containing the rules for payment for home care devices and their accessories.

In another aspect of the invention, a patient server is described that includes a patient interface receiving information from a patient site, including information about a home care device disposed at the patient site; a database including eligibility rules; and a processor receiving said information, analyzing the information using the eligibility rules, and generating a reminder message when the device is eligible for payment based on said rules.

In some instances, a home care device is originally leased or rented by the patient and a special monitor is used to sense when and how often is the device used. This information is provided to the system to determine if a patient is eligible to buy the device outright and to receive payment for the purchase from the payor.

In an alternate embodiment, a method and system of dispensing drugs to patients is described including generating a prescription; providing a drug to a patient based on said prescription, providing information about the drug to a patient server, analyzing the information periodically with the server; and sending a reminder message to a patient when the prescription needs to be renewed or is expiring. If the patient indicates that he wants his prescription renewed, the system automatically contacts a courier and arranges for the prescription to be delivered to the patient.

### BRIEF DESCRIPTION OF THE DRAWINGS

FIG. 1 shows an Internet-based system for monitoring the deployment and use of home care devices in accordance with this invention;

FIG. 2 shows a block diagram of a patient server that collects information and provides patient reminders in accordance with this invention;

FIG. 3 shows a flow chart for data collection for the server of FIG. 2;

FIG. 4 shows a flow chart of the operation of the server of FIG. 2;

FIG. 5 shows a flow chart of an alternate mode of operation of the server of FIG. 2; and

FIG. 6 shows a flow chart for the server of FIG. 2 generating reminders for prescriptions.

### DETAILED DESCRIPTION OF THE INVENTION

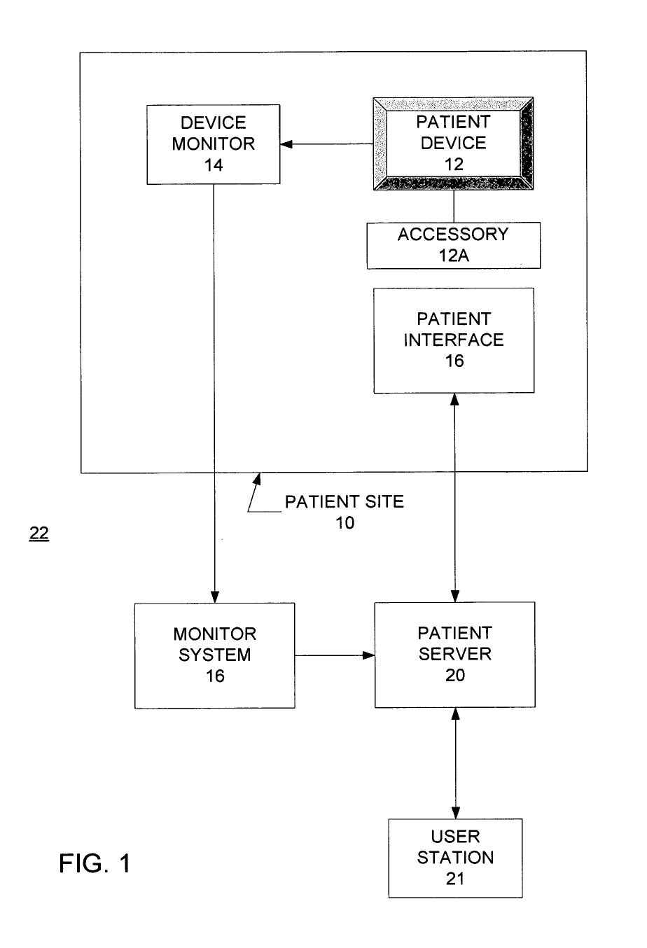

As shown in FIG. 1, patient site 10 (representing a patient's home or other location for providing patient therapy and/or monitoring) includes a patient device 12, a device monitor 14, and a patient interface 16. The patient device 12 may be a respiratory device, a cardiac monitor, a blood pressure sensor, or any other home care device used to measure a parameter related to the health of a patient and/or to provide therapy to the patient. The device may include or be associated with an accessory 12A that may need replacement or replenishment at regular intervals. For example, a device for treating sleep apnea may include a replaceable mask.

The device 12 is coupled to a device monitor 14 that monitors the use of the device 12 and generates monitor signals to a device monitor system 18. The device monitoring system 18 is preferably disposed at a remote location and is used to collect information from a variety of device monitors and, optionally, to collate this information and display it in various forms. The information is transmitted from the device monitor 14 to the device monitor system 18 by any well known wired or wireless communication link. The device monitor 14 can provide various types of information about patient device 12 and the respective patient. For the purposes of this application, the information that is important is whether the patient device 12 is being used. For example, the device monitor 14 can provide information on how often the patient device 12 has been used in the last seven days, and for how long.

In addition, as shown in FIG. 1, the patient communicates through the patient interface 16 with a patient server 20. The purpose of this server is to keep track of various patient devices and related accessories, and perform a variety of functions, as discussed in more detail below. The patient server 20 and the device monitor system 18 could be integrated into a single system, however, they are shown here as discrete components for the sake of clarity.

The patient server 20 obtains information directly from the patient through patient interface 16. For example, the patient interface 16 may be a PC communicating with the server through a standard Internet connection. Alternatively, the patient information may be received by the patient server from the HME or the doctor.

Finally, the patient server also communicates with a user station 21. This station 21 is disposed at the site of a user, e.g., an HME office or a doctor's office, to provide access the patient server 20 for various services, as discussed in more detail below. Communication between user station 21 and patient server 20 takes place either over the Internet, or through other secure communication channels.

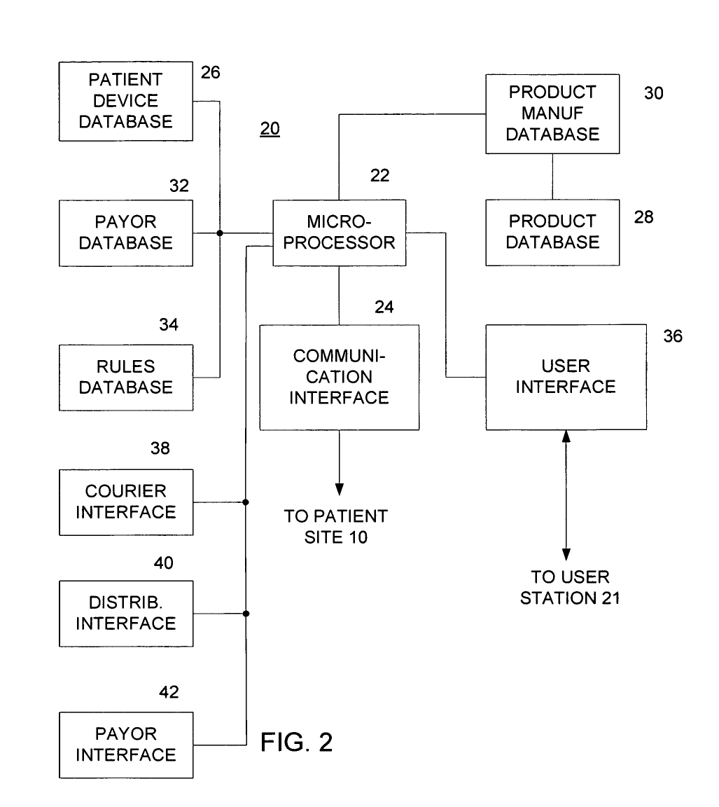

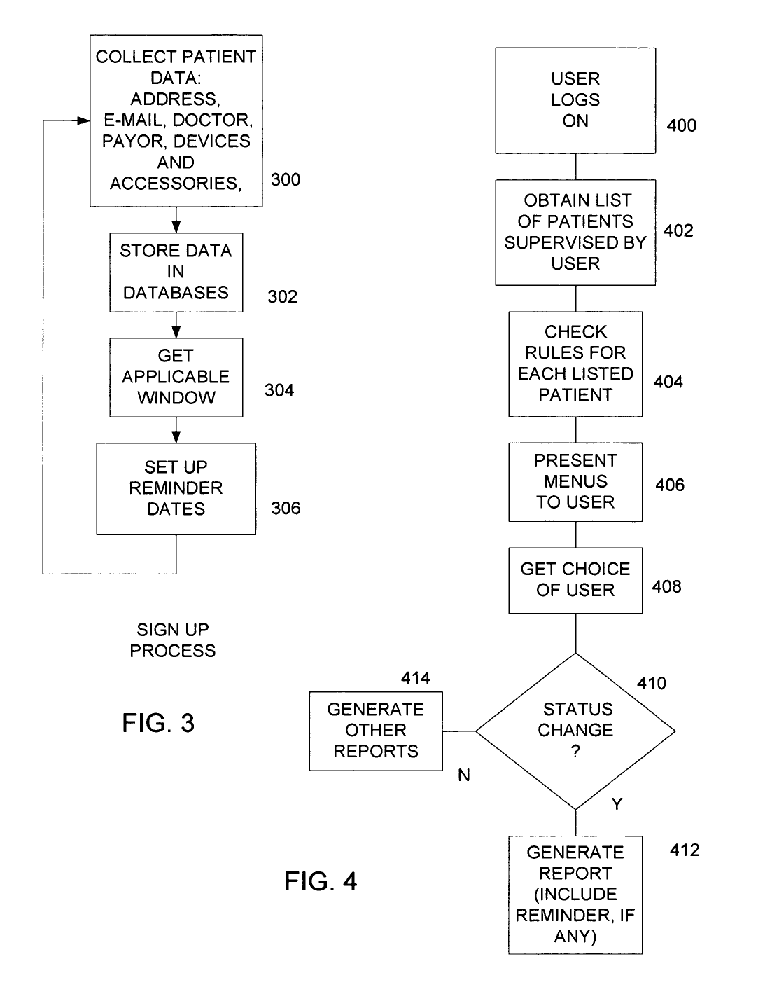

As shown in FIG. 2, the patient server 20 includes a microprocessor 22, a communication interface 24, and a plurality of databases. Patient database 26 contains information received from the clients being serviced by patient server 20, including an identification of each patient device 12 and its accessories at each patient site 10, as well the patient's personal information, including name, home address, e-mail address, prognosis, name of the doctor, date on which the device 12 was delivered, etc.

Product database 28 contains a listing of all the devices found at the sites of the various patients. Product manufacturer database 30 contains information about the manufacturers of the products listed by database 28. Payor database 32 contains a list of all the payors associated with, or having the obligation to pay for the patient devices and accessories. Finally, the rules database 34 contains the rules used by the payors of database 32 to determine under what conditions and when will each payor pay for the devices of database 26.

The server 20 receives information from different patients through the communication interface 24.

A user accesses the server through a user interface 36.

Initially, when a patient receives a home care device 12, he is asked to register with the server 20. The registration process (step 300) consists of providing information such the patient's name, home address, e-mail address, the name of his physician, the manufacturer and model number of the home care device and any accessories, the name of the payor (usually an HMO) and so on. This information is stored in the patient database 26 by microprocessor 22. Next, in step 302, the databases shown in FIG. 2 are updated using information from the patient. In addition, the databases are also updated on a regular basis with information received from the payors or the device manufacturers.

Once the databases are set up and populated, various users can access the same and obtain information. Different classes of users can be defined, with some users having only data reading capability and obtaining information only associated with some of the patients, while other users being capable of obtaining information about all the patients, being authorized to send communications to the patients or to make changes to the server 20. The information may be presented to the user in a number of different formats. Since the information is stored in databases, preferably, the information is presented in the form of reports, using database manipulating software programs, such as FoxPro.

FIG. 4 shows a typical session by a user of the apparatus of FIG. 2. The user is logged on and identified in step 400. In step 402, a list of patients assigned to the user is obtained and presented. In one embodiment, in step 404 a check is performed on all the listed patients to determine whether their status has changed, i.e., whether the patient may have become eligible either for a reimbursement for his medical device, or for the replacement of the device or an accessory associated with the device. For example, it has been found that in many instances, a patient receives a home care device, but then he never uses it. Therefore, at least some payors initially require that the patient enter into some kind of leasing or rental arrangement whereby the home care device is leased or rented for a predetermined period, e.g., 6 months, or a year. If the patient expresses an interest at the end of the period in buying the device, the payor may fully or partially reimburse the patient. The payor may also require that the patient use the equipment a number of times, or for a predetermined duration. This information is obtained from the device monitor system 18 and stored in the patient database 26. This process is referred to as a conversion.

Once the rules are checked, the results are stored in the patient database as well. In step 406, the user is presented with several choices of menus. Some of these menus provide biographic information about the patient. Some menus provide information about the products. Some menus provide information about what accessories are available with the prescribed device.

In step 408, the user makes a menu selection. In step 410, a check is performed to determine if the selected menu includes or refers to an item that may change status. For example, the patient information may include an entry indicating that a patient device can be converted. If such a status change is detected then, in step 412 a report is generated including an indication of what payment the patient is entitled to, which device is eligible, when a request is to be filed to obtain payment, and so on.

In a similar manner, as previously discussed, the user may request a menu pertaining to accessories that are, or include a replaceable element. For example, a breathing device may have a replaceable mask. Other devices may require that a filter or a battery be replaced. In this case, a similar report is generated for the accessory in step 412. In some instances the actual device may be replaced,

If the selected menu does not involve any item that is replaceable, then in step 414, other reports are generated for the user. These reports could cover a large variety of subjects including status reports about the patients, sales, specific dates on which devices was dispensed or deployed, the dates on which the devices were converted, and so on.

The form of the report in step 412 and the services provided to the user can be very different, dependent on governmental regulations, the programming of the server 20, the choices made by the user, etc. For example, the user may get a simple indication or reminder that one or more patients are eligible to convert their home care device. The indication could consist of an identification of the patient, the device affected, the payor, and any critical dates associated with the conversion. These critical dates could include the first day and the last day on which the patient was eligible.

In a more sophisticated or semi-automated embodiment, instead of, or in addition to the simple reminder, an electronic form letter may be generated and populated by the server 20 using information from the databases. The user is then presented with a copy of the letter on the display 38 and if the user approves the letter, it can be printed, and sent to the patient. The letter provides to the patient all the information needed to convert his device to an ownership rather then a rental. Alternatively, the letter may only inform the patient there was, or there is going to be a change in his status and that he should contact the server for further information. The letter could also be faxed or e-mailed to the patient. Of course, the user can call up the patient, as well.

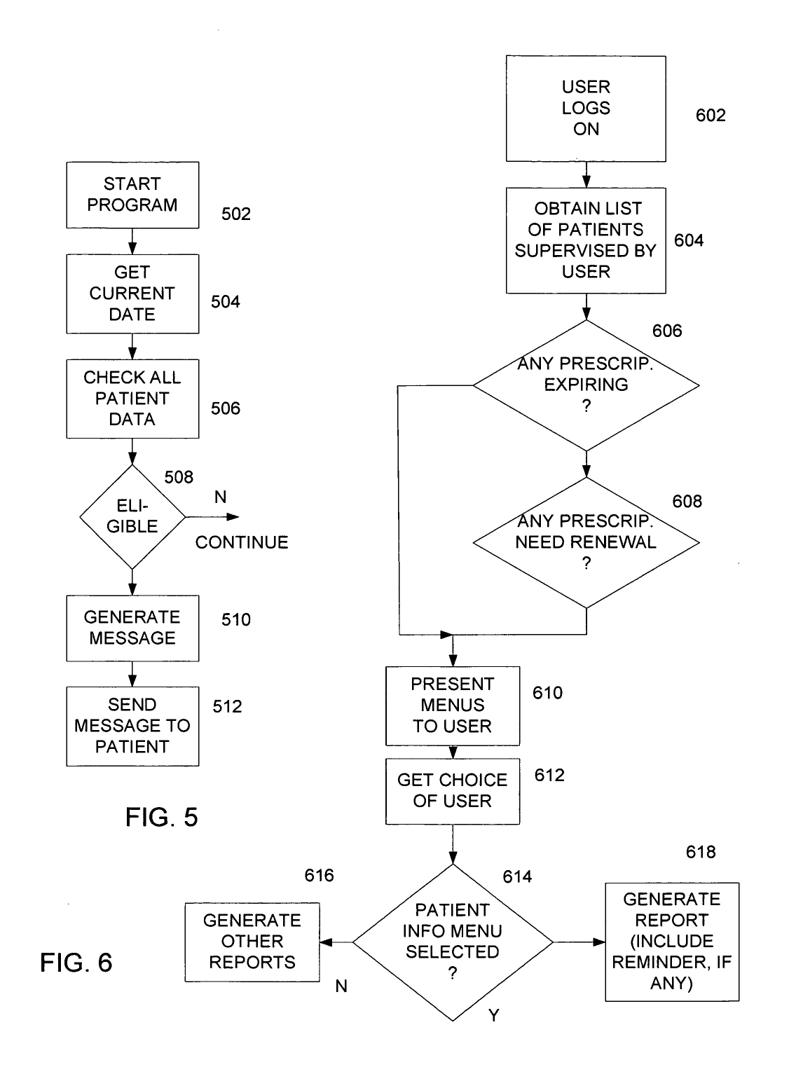

In the embodiment described above, the process for checking whether the status of a serviced patient has changed is triggered when a user associated with that patient signs on to the server 20. In an alternate embodiment, the process can be automated further so that it is completely independent of any action taken by a user. More specifically, referring to FIG. 5, in step 500 a program operating the server is started. (For example, the apparatus 20 is booted up). In step 502, the current date is obtained. In step 504, all the databases are checked by using the predetermined rules discussed above to locate any patient whose status has changed. This status change is indicative of the patient being eligible for a conversion, reimbursement, replacement etc.

In step 506, a check is performed to determine if there were any such eligible patients are located. If not, then normal operation continues. If one or more eligible patients are identified, then reminders are generated and presented or mailed to the user(s) when convenient. Alternatively, an appropriate message is generated, in step 508, and sent to the each of the eligible patients, in step 510. The message can take any appropriate form, such as by fax or e-mail. This process could be implemented so that the eligible patients are identified and notified completely automatically.

Once a patient receives a reminder, he can then contact the respective user and put in an order for the item mentioned in the reminder. The user can then fulfill the order by mailing the item to the patient. In many instances, the item being replaced is not discarded, but must be returned to the manufacturer. Advantageously, since the patient server 20 has all the required information, once the user receives an order from the patient, he can then request the patient server to send out a pick up request to a courier service, through courier interface 38. The request includes all the necessary information, including the patient's name, address, and the item that is to be picked up. Moreover, at the request of the user, the patient server can also generate an order to requested item to a distributor through the dealer interface 40 (the order could also be sent to the manufacturer of the requested item, or a local dealer). Additionally, the user may also request the patient server 20 to send documentation to the respective payor with details of the whole transaction, through a payor interface 42. The payor sends a payment to the user.

A typical system using the patient server operates as follows. Several patients receive prescriptions from their doctors for certain devices, such as CPAP devices (used for sleep apnea therapy). The local Home Medical Equipment dealer (HME) and the doctors are all users of the patient server.

Each patient receives the HME his CPAP device 12, accessories, such as a mask, and an associated device monitor 14. The patient then registers with the patient server 20, listing his device, accessory and his payor. The data is entered into the databases 26, 28, 30, 32. The patients' payors pay the initial cost of the CPAP devices and the masks. In addition, it is assumed for this discussion that some of the payors also pay for a replacement for the mask at regular intervals (e.g., yearly).

Typically, several HMEs may be the users of the patient server 20, each dealing with its own group patients, devices, manufacturers and payors, all listed in the respective databases of the patient server 20.

Each HME becomes a user by gaining user rights from the patient server (for example by obtaining a software module).

The patients start using the CPAP devices. The device monitors gather information regarding the patients' activities and send the information for recordation to the monitor system 18 through a pager system, a cellular telephone system, over a wired communication channel, etc.

Each time one of the HMEs logs on, the patient server 20 determines whether the status of any of the patients of this HME has changed. After a predetermined time, for example, a year, the accessories of several patients become eligible for replacement and an appropriate reminder is generated by the server to the user. The HME sends a message to the patient offering the replacement mask. If the patient agrees, the user can execute the order manually. Alternatively, the user requests the patient server to execute the order. The patient server then sends a request to the courier service to pick up the old mask. The patient server may also request the courier service to pick up the replacement mask from the HME, a dealer or other source, take it to the patient and exchange it for the old mask. The old mask is returned to the HME or other designated organization. The patient server also sends a request for payment to the HME by the payor. If the rules stored in database payor database 18 indicate that the payor requires validation of the use of the device, such validation is provided by the patient database 28 from information collected by the monitor system 18. The payor then sends payment to the HME.

As mentioned above, doctors (or other health care providers) can also sign up as users of the patient server, for example, by obtaining their own software module. The doctors can use the patient server to collect statistical data about several of their own patients, patients of other doctors, etc. The doctors may also check on each of their patients to determine whether, based on the data from the monitor system 18, the prescribed treatment has been followed.

The subject invention has been described in conjunction with a home care device in a patient' residence. Alternatively, the invention is used for dispensing various other materials related to health. For example, many patients, including the elderly, receive prescriptions for drugs. In order to prevent abuse, the prescriptions must be renewed at predetermined intervals (for example, once a month) and expire after a predetermined period (for example, a year) and the patient must visit his doctor and get a new prescription. The present invention is applicable for this environment as well. In this case, the server 20 receives information from the patient, or from an alternate source (e.g. the physician) regarding the details of a prescription. The information may also be entered by a pharmacist.

The server 20 automatically checks the status of the prescription and generates reminders, when appropriate. For example, in one embodiment shown in FIG. 6, the user logging in triggers the calculations for the reminder. In this embodiment, the user logs in step 602, a list of patients is obtained in step 604, and a check is performed, in step 606, to determine if any prescription of the respective patients is expiring within a predetermined time (e.g., next seven days). If not, then in step 608 a check is performed to determine if any patient prescription requires renewal within a predetermined interval (e.g., next three days). This data is entered into one of the databases, such as the patient database 26. Next, the user is presented with menus for selecting reports (step 610). In step 612, the user chooses a menu. In step 614, a check is made to determine if the chosen menu includes patient information. If it does, then a report is generated, including a reminder indicating, if appropriate, that a patient prescription needs to be renewed or a new prescription is needed. The user can then send a regular letter, a fax or an e-mail to the patient to that effect. Other reports are generated, in step 616, including, for instance, reports on what drugs were prescribed by specific doctors, etc.

Alternatively, the server 20 can perform checks and generate automated reminders directly to the patients, as described above.

In any of the embodiments, when a prescription renewal is required, the patient can be notified by mail, fax, e-mail, telephone, etc., as discussed. In an alternate embodiment, the patient may respond that he will wants to renew the prescription. The pharmacist can then prepare the new prescription and have it ready to be picked up by the patient. Alternatively, when the patient server receives the acceptance from the patient it may issue a request to a courier to pick up the medicine and ship it immediately to the user.

Special devices, accessories or medicines with low circulation may be flagged by the device database 30. These may be items that may not be carried normally by the HME. When a reminder is generated for any of these special items, or for any item that may be out of stock, or not carried by the HME, the patient server 20 generates orders to dealers, distributors, manufacturers, or other pharmacies alerting them that there will be need for that item. These other organizations can then start taking the necessary steps to obtain and ship the item the patient.

Obviously numerous modifications can be made to this invention without departing from its scope, as defined in the appended claims.

1. A patient server comprising:
a patient interface receiving information from a plurality of sites, each site including a home care device; and
a processor receiving said information and making a determination based on said information regarding eligibility of a patient associated with a site for a payment associated with said home care device, said processor generating a reminder message when said patient is found to be eligible.

2. The patient server of claim 1 further comprising a display, said display generating a reminder to a user based on said reminder message,

3. The patient server of claim 1 wherein said processor generates a reminder letter to a customer based on said reminder message.

4. The patient server of claim 1 wherein said processor generates said reminder message when the patient is eligible for a device conversion.

5. The patient server of claim 1 further comprising an accessory associated with said device, wherein said processor generates said reminder message when said accessory can be replaced.

6. The patient server of claim 1 further comprising a database defining rules determining said eligibility.

7. A patient server comprising:
a patient interface receiving information from a patient site, including information about a home care device disposed at said patient site;
a database including eligibility rules; and
a processor receiving said information, analyzing said information using said eligibility rules, and generating a reminder message when said device is eligible for a status change based on said rules.

8. The patient server of claim 7 wherein said device is eligible for a conversion.

9. The patient server of claim 7 further comprising an accessory associated with said device and wherein said message includes information regarding the replacement of said accessory.

10. The patient server of claim 7 further comprising a database including device manufacturer data descriptive of manufacturers making the device.

11. The patient server of claim 10 further comprising a device database with data describing a plurality of devices made by said manufacturers.

12. A method of generating a payment to a patient with a home care device at his site comprising:
storing at a central location information regarding the device;
storing a set of rules describing device payments;
generating an output message related to payment for said device by analyzing said set of rules using said information; and
presenting said message.

13. The method of claim 12 wherein further comprising storing in said database a list of manufactures making said device and generating said output message using rules applied to said list.

14. The method of claim 13 further comprising to storing device data descriptive of said device and using said device data with said set of rules.

15. The method of claim 12 further comprising sending a patient message to the patient based on said output message.

16. A method of dispensing drugs to patients comprising: generating a prescription;
providing said a drug to a patient based on said prescription;
providing information about the drug to a central station;
at the central station analyzing said information; and
sending a reminder message to a patient when said prescription needs to be renewed or replaced.

17. The method of claim 16 wherein said reminder message is a fax.

18. The method of claim 16 wherein said reminder message is e-mail.

19. The method of claim 16 wherein said reminder message is sent days before the prescription expires.

20. A method of distributing medical devices and associated accessories comprising the steps:
providing patients with the devices;
registering with a patient server the patients, the corresponding devices, and a set of rules regulating the replacement of the devices or their accessories;
checking with said patient server when a device or accessory becomes eligible for a replacement device or accessory; and
generating a corresponding reminder message.

21. The method of claim 20 further comprising sending said a message to the patient indicating that his device or accessory is eligible for replacement.

22. The method of claim 21 further comprising receiving a response from the patient and generating by said patient server an order.

23. The method of claim 21 wherein said device or accessory has to be collected further comprising generating a pickup request by said patient server, sending said pickup request to a courier, and picking up the device or accessory by said courier.

24. The method of claim 20 wherein said rules require a predetermined usage of the device for eligibility, further comprising monitoring the usage of the device, collecting information regarding said usage and providing said information to a payor.
